(19) United States
(12) Patent Application Publication
(10) Pub. No.: US 2008/0011341 A1
(43) Pub. Date: Jan. 17, 2008

(54) Dish washing machine

(75) Inventors: Eui Soo Kim, Suweon-si (KR); Yong Woon Han, Gunpo-si (KR); Young Ho Kwon, Seongnam-si (KR); Shimotera Kennichi, Seoul (KR); Sung Jin Kim, Suweon-si (KR); Jung Chan Ryu, Suwon-si (KR); Jae Young Choi, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD., Suwon-si (KR)

(21) Appl. No.: 11/806,522

(22) Filed: May 31, 2007

(30) Foreign Application Priority Data
Jul. 12, 2006 (KR) 10-2006-0065593

(51) Int. Cl. B08B 3/02; B08B 3/04

(52) U.S. Cl. 134/56 D

(57) ABSTRACT

A dish washing machine capable of controlling the amount of wash water used based on the quantity of dishes and preventing a drop of the injection pressure of the wash water. The dish washing machine includes a washing tub, main nozzles disposed in the washing tub to constantly inject wash water when washing dishes, a sub nozzle disposed in the washing tub to selectively inject wash water when washing dishes, a sump mounted in the wash tub, a main channel disposed in the sump, the main channel being connected with the main nozzles, a sub channel disposed in the sump while being separated from the main channel and connected to the sub nozzle, and a channel control valve disposed in the sub channel to intermit a flow of wash water flowing to the sub nozzle.

### CROSS-REFERENCE TO RELATED APPLICATIONS

This application claims the benefit of Korean Patent Application No. 10-2006-0065593, filed on Jul. 12, 2006 in the Korean Intellectual Property Office, the disclosure of which is incorporated herein by reference.

### BACKGROUND OF THE INVENTION

1. Field of the Invention

The present invention relates to a dish washing machine. More particularly, to a dish washing machine that is capable of controlling the amount of wash water injected based on the quantity of dishes and preventing an abrupt drop of the injection pressure of the wash water.

2. Description of the Related Art

A conventional dish washing machine is a machine that automatically washes dishes using cold water or hot water. The conventional dish washing machine includes a machine body, a washing tub formed in the machine body, baskets mounted in the washing tub, and main and sub nozzles mounted at the upper part, the middle part, and the lower part of the washing tub to inject wash water, as disclosed in Korean Unexamined Patent Publication No. 2004-47017.

A sump is mounted at the bottom of the washing tub to receive wash water and to pump the wash water to the respective nozzles. The sump includes a sump housing forming an external appearance of the sump, a washing impeller mounted in the sump housing to pump wash water, upper and lower channels to guide the wash water pumped from the washing impeller to the respective nozzles, a channel control valve mounted at a channel branch point to control the flow of wash water, and a pump motor mounted at the outside of the sump housing to drive the washing impeller.

In the conventional dish washing machine, however, the upper and lower nozzles are disposed in the washing tub, and wash water is injected simultaneously or alternately through the upper and lower nozzles. As a result, the wash water is excessively consumed.

Furthermore, the channel control valve is mounted in the channel, along which wash water is guided to the upper and lower nozzles. As a result, all the wash water passes through the channel control valve. Consequently, when the flow of the wash water is changed by the channel control valve, the injection pressure of the wash water is lowered.

### SUMMARY OF THE INVENTION

Accordingly, it is an aspect of the present invention to provide a dish washing machine capable of controlling the amount of wash water used based on the quantity of dishes.

It is another aspect of the invention to provide a dish washing machine capable of preventing a drop of the injection pressure of wash water, when the wash water is injected, thereby improving the washing efficiency.

Additional aspects and/or advantages of the invention will be set forth in part in the description which follows and, in part, will be apparent from the description, or may be learned by practice of the invention.

The foregoing and/or other aspects of the present invention are achieved by providing a dish washing machine including a washing tub, main nozzles disposed in the washing tub to constantly inject wash water when washing dishes in the washing tub, a sub nozzle disposed in the washing tub to selectively inject wash water when washing dishes, a sump mounted in the wash tub to receive wash water and to pump the wash water to the respective nozzles, a main channel disposed in the sump and connected to the main nozzles, a sub channel disposed in the sump while being separated from the main channel, the sub channel being connected to the sub nozzle, and a channel control valve disposed in the sub channel to intermit the flow of wash water flowing to the sub nozzle.

The sump includes a washing impeller to pump the wash water and an impeller casing including an impeller receiving part in which the washing impeller is received, and the main channel and the sub channel are formed at the impeller casing such that the main channel and the sub channel diverge from the impeller receiving part.

According to an aspect of the present invention, the channel control valve is rotatably mounted in an inlet of the sub channel.

According to an aspect of the present invention, the main channel extends from the impeller receiving part to an edge of the impeller casing in a shape of a curve to prevent an instantaneous drop of the injection pressure of wash water flowing along the main channel.

According to an aspect of the present invention, the impeller casing includes a filth chamber communicating with the main channel to collect dirt mixed with wash water.

According to an aspect of the present invention, the main channel, the sub channel, and the filth chamber are integrally formed at the impeller casing.

According to an aspect of the present invention, the sub channel includes a valve engaging hole, in which the channel control valve is engaged. The dish washing machine further includes a valve driving motor disposed below the valve engaging hole, the valve driving motor being coupled with the channel control valve.

According to aspect of the present invention, the dish washing machine further includes a motor shaft extending from the valve driving motor, the motor shaft being coupled with the channel control valve, a cam coupled with the motor shaft, and a sensor to contact an outer circumferential face of the cam and to detect the motion of the channel control valve.

The sensor includes a sensor arm to move with a movement of the cam, a roller coupled with one end of the sensor arm, the roller contacting the outer circumferential face of the cam, a sensor body, to which the other end of the sensor arm is fixed, and a sensor switch disposed at the sensor body such that the sensor switch is brought into contact with or is separated from the sensor arm.

According to an aspect of the present invention, the channel control valve is a two-way valve including an upper disk, a lower disk disposed below the upper disk such that the lower disk is spaced a predetermined distance from the upper disk, first and second ribs connected between the upper disk and the lower disk, the first and second ribs being separated from each other, and first and second openings defined between the first rib and the second rib.

It is another aspect of the present invention to provide a dish washing machine including a washing tub, main nozzles disposed in the washing tub to constantly inject wash water when washing dishes, a sub nozzle to selectively inject wash water, a sump mounted in the wash tub to pump wash water to the sub nozzle and the main nozzles, a main channel disposed in the sump and connected with the main nozzles to guide wash water to the main nozzles, a sub channel disposed in the sump, the sub channel being connected to the sub nozzle to selectively guide wash water to the sub nozzle, a channel control valve disposed in the sub channel to open and close the sub channel to thereby intermit the flow of wash water, and a filth chamber communicating with the main channel to collect dirt contained in wash water.

According to an aspect of the present invention, the sump includes a washing impeller to pump the wash water, an impeller casing having an impeller receiving part, in which the washing impeller is received, and an impeller casing cover to cover the impeller casing. The main channel and the sub channel are formed at the impeller casing such that the main channel and the sub channel diverge from the impeller receiving part. The impeller casing cover includes a guide channel communicating with the sub channel to guide the wash water from the sub channel to the sub nozzle.

The dish washing machine further includes a feeding pipe connected between the sump and the main nozzles, and the feeding pipe is disposed adjacent to the edge of the sump, and the sub nozzle is rotatably coupled with a center of the sump.

According to an aspect of the present invention, the channel control valve is a two-way valve.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a side sectional view of a dish washing machine according to an embodiment of the present invention;

FIG. 2 is a perspective view illustrating an interior of a machine body of the dish washing machine according to an embodiment of the present invention;

FIG. 3 is an exploded perspective view of a sump according to an embodiment of the present invention;

FIG. 4 is an exploded perspective view of a channel control valve and a valve driving motor according to an embodiment of the present invention;

FIG. 5 is a plan view illustrating a sub channel opened for wash water to flow therethrough, according to an embodiment of the present invention;

FIG. 6 is a plan view illustrating an operation of the valve driving motor when the sub channel is opened, according to an embodiment of the present invention;

FIG. 7 is a plan view illustrating the sub channel closed so that wash water cannot flow therethrough, according to an embodiment of the present invention;

FIG. 8 is a plan view illustrating an operation of the valve driving motor when the sub channel is closed, according to an embodiment of the present invention;

FIGS. 9 and 12 are assembled perspective views of the sump, according to an embodiment of the present invention;

FIG. 10 is an assembled perspective view of a sump housing and an impeller casing, according to an embodiment of the present invention; and

FIG. 11 is a perspective view illustrating an impeller casing cover coupled to the sump housing, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the figures.

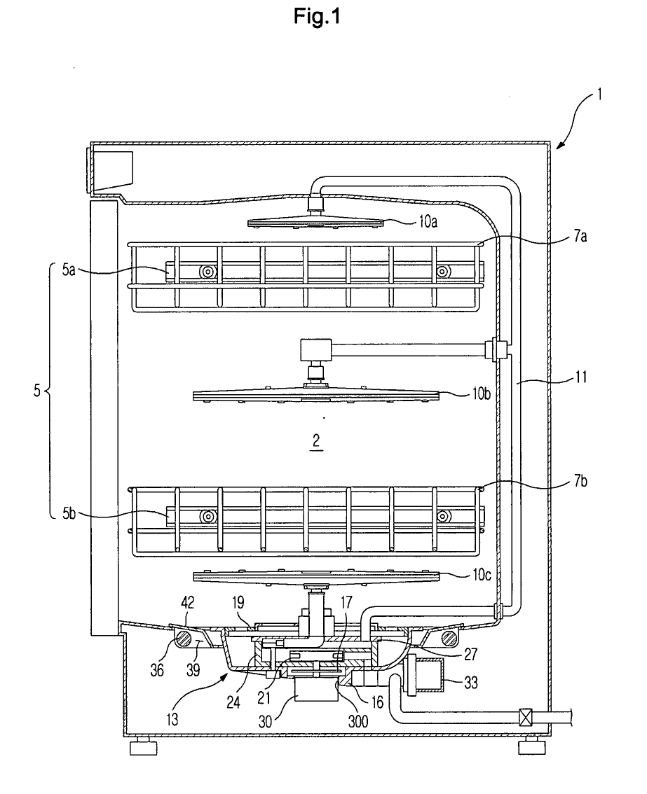

As shown in FIG. 1, a dish washing machine according to an embodiment of the present invention, comprises a machine body 1 forming the external appearance of the dish washing machine, a washing tub 2 disposed in the machine body 1, and a rack 5 fixed to a sidewall of the washing tub 2. The rack 5 comprises an upper rack 5a and a lower rack 5b, by which an upper basket 7a and a lower basket 7b are supported, respectively. Dishes are placed in the upper basket 7a and the lower basket 7b.

At an upper part, a middle part, and a lower part of the washing tub 2 are mounted main nozzles 10a and 10b and a sub nozzle 10c, respectively, to inject wash water. The wash water injected through the nozzles 10a, 10b and 10c is directed toward the baskets 7a and 7b. The nozzles 10a, 10b and 10c are rotated by the injection pressure of the wash water injected through the nozzles 10a, 10b and 10c. The wash water injected through the nozzles 10a, 10b, and 10c collides with the dishes in the baskets 7a and 7b to strongly wash the dishes.

A sump 13 is mounted at the bottom of the washing tub 2 to receive, pump, and supply wash water to the respective nozzles 10a, 10b and 10c.

At the rear of the washing tub 2 is disposed a feeding pipe 11 to supply wash water to the main nozzles 10a and 10b. The lower end of the feeding pipe 11 is connected with the sump 13. Consequently, the wash water flows to the main nozzles 10a and 10b through the feeding pipe 11 due to strong pumping pressure of the sump 13.

The sub nozzle 10c is directly connected with an upper center part of the sump 13. Consequently, some of the wash water is injected through the sub nozzle 10c to wash dishes placed in the lower basket 7b, adjacent to the sub nozzle 10c.

When the quantity of dishes is small, the dishes may be placed only in the upper basket 7a, and wash water be injected only through the main nozzles 10a and 10b while the wash water is not injected through the sub nozzle 10c, and vice versa.

The sump 13 comprises a sump housing 16 forming an external appearance of the sump, a sump cover 19 to cover the sump housing 16, a washing impeller 21 disposed in the sump housing 16, an impeller casing 24 to which the washing impeller 21 is mounted, and an impeller casing cover 27 disposed on the impeller casing 24.

At the bottom of the sump housing 16 is mounted a pump motor 30 to drive the washing impeller 21. Specifically, the pump motor 30 is coupled with the sump housing 16 by means of screws, for example. A pump motor receiving part 300 is disposed at the bottom of the sump housing 16 such that the pump motor 30 is received in the pump motor receiving part 300.

At the side of the sump housing 16 is mounted a drainage pump 33 to discharge wash water and dirt in the sump 13 out of the dish washing machine.

At the edge of the sump 13 is mounted a heater 36 to heat wash water. At the bottom of the washing tub 2 is formed a heater receiving groove 39, which extends along the edge of the sump 13. The heater 36 is received in the heater receiving groove 39.

After the heater 36 is received in the heater receiving groove 39, the heater 36 is covered by a heater cover 42 to prevent the heater 36 from being exposed to the outside.

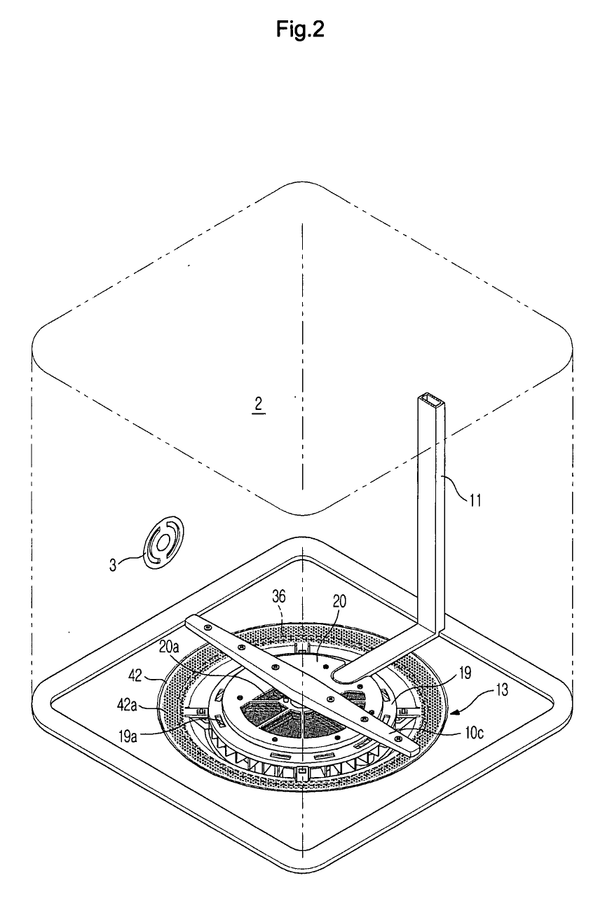

As shown in FIG. 2, an inlet port 3 is formed through one side of the washing tub 2 such that wash water can be introduced into the washing tub 2 through the inlet port 3. Wash water introduced through the inlet port 3 falls to the bottom of the washing tub 2 and is introduced into the sump 13.

The sub nozzle 10c is rotatably coupled with a center of the sump 13. The feeding pipe 11 is connected with a rear end of the sump 13 such that wash water is supplied to the main nozzles 10a and 10b (see FIG. 1) through the feeding pipe 11.

The sump cover 19 is mounted on the sump 13. Along an edge of the sump cover 19 are formed inlet holes 19a, which are arranged in regular intervals. Consequently, wash water is introduced into the sump 13 through the inlet holes 19a.

On the sump cover 19 is mounted a filter cover 20. A mesh filter 20a is mounted to the filter cover 20 to prevent dirt collected in a filth chamber (not shown), which will be described below, from overflowing from the filth chamber and to allow only wash water to flow out of the filth chamber.

The heater 36 is mounted at the edge of the sump 13 in a shape of a ring. The heater cover 42 is mounted on the heater 36. The heater cover 42 comprises a plurality of through-holes 42a, through which wash water flows to the heater 36. The wash water is heated by the heater 36, and is then introduced into the sump 13.

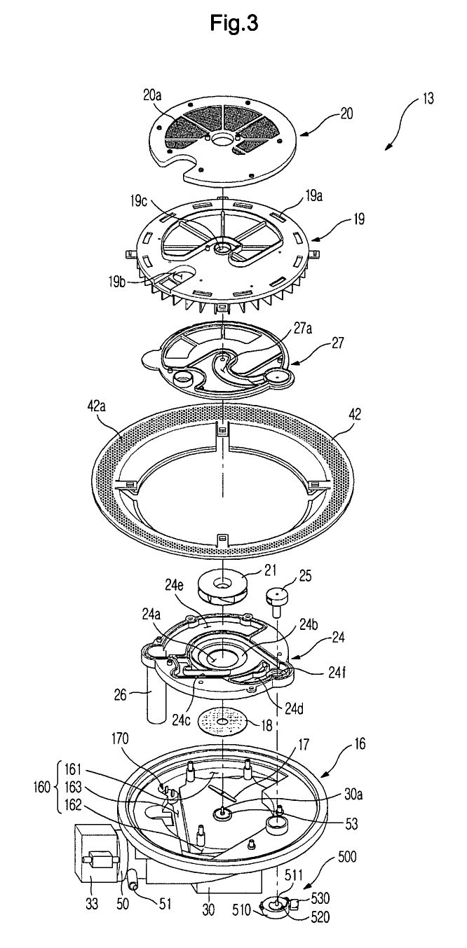

FIG. 3 illustrates the structure of the sump 13, according to an embodiment of the present invention. At one side of the sump housing 16 is disposed a pump fixing part 50, to which the drainage pump 33 is fixed. To one side of the pump fixing part 50 is connected a drainage pipe 51, through which wash water and dirt are discharged.

The pump motor 30 is mounted at a bottom of the sump housing 16. A rotary shaft 30a of the pump motor 30 extends through the bottom of the sump housing 16.

At the lower center part of the sump housing 16 is disposed a sealing member 53, which surrounds the rotary shaft 30a to prevent wash water from leaking to the pump motor 30. The rotary shaft 30a of the pump motor 30 extends through the top of the pump motor receiving part 300. A cutter 17 is mounted to the rotary shaft 30a to crush dirt contained in the wash water.

The pump motor 30 is mounted at the bottom of the sump housing 16 to the pump motor receiving part 300. Around the pump motor receiving part 300 is disposed a drainage channel 160, which surrounds the pump motor receiving part 300. The drainage channel 160 comprises first, second and third drainage channels 161, 162 and 163 surrounding the pump motor receiving part 300. The first and second drainage channels 161 and 162 communicated with each other through the third drainage channel 163, which guides wash water and dirt to the drainage pump 33. Between the first drainage channel 161 and the third drainage channel 163 is disposed a turbidity sensor 170 to detect the turbidity of wash water.

The impeller casing 24 is disposed on the sump housing 16. The impeller casing 24 comprises a communication hole 24a at a center thereof, which communicates with the sump housing 16. Around the communication hole 24a is disposed an impeller receiving part 24b, in which the washing impeller 21 is received.

The washing impeller 21 is coupled with the rotary shaft 30a of the pump motor 30 such that the washing impeller 21 is rotated to pump wash water introduced into the sump housing 16 upward. A filter 18 is provided to prevent large amounts of dirt from being flowed in the washing impeller 21.

The impeller casing 24 comprises a main channel 24c and a sub channel 24d, which diverge from the impeller receiving part 24b. The main channel 24c guides wash water to the main nozzles 10a and 10b (see FIG. 1). The sub channel 24d guides wash water to the sub nozzle 10c (see FIG. 1).

A channel control valve 25 is rotatably mounted in the sub channel 24d to intermit a flow of wash water to the sub channel 24d. When the quantity of dishes to be washed is small, the sub channel 24d is closed by the channel control valve 25 such that wash water can flow only to the main channel 24c.

A valve engaging hole 24f is formed in the inlet side of the sub channel 24d, in which the channel control valve 25 is rotatably engaged.

Below the channel control valve 25 is disposed a valve driving unit 500 to drive the channel control valve 25. The valve driving unit 500 comprises a valve driving motor 510 to drive the channel control valve 25, a cam 520 coupled with a rotary shaft 511 of the valve driving motor 510, and a position detecting sensor 530 to detect a rotational position of the channel control valve 25 through the cam 520.

Wash water flowing along the main channel 24c is injected through the main nozzles 10a and 10b (see FIG. 1) to wash dishes. Consequently, the amount of wash water used is reduced when the quantity of dishes to be washed is small.

A filth chamber 24e is formed beside the main channel 24c to collect dirt introduced into the main channel 24c together with wash water. Adjacent to the inlet of the filth chamber 24e is mounted a drainage connection pipe 26, which is connected to the drainage pump 33. When the drainage pump 33 is operated, dirt collected in the filth chamber 24e is discharged to the drainage pipe 51 through the drainage connection pipe 26.

The impeller casing cover 27 is disposed on the impeller casing 24. A guide channel 27a is formed at the impeller casing cover 27 and communicates with the sub channel 24d. The guide channel 27a extends from an edge of the impeller casing cover 27 to a center of the impeller casing cover 27 in a shape of a curve.

Consequently, when the sub channel 24d is opened by the channel control valve 25, wash water pumped by the washing impeller 21 passes through the channel control valve 25, and flows along the sub channel 24d. At this time, the wash water is guided to the sub nozzle 10c (see FIG. 1) along the guide channel 27a, which communicates with the sub channel 24d, and is then injected through the sub nozzle 10c.

The sump cover 19 is disposed on the impeller casing cover 27. In the center of the sump cover 19 is formed an engaging hole 19c, in which the lower end of the sub nozzle 10c (see FIG. 1) is engaged. The inlet holes 19a, through which wash water is introduced, are formed along the edge of the sump cover 19 such that the inlet holes 19a are arranged in regular intervals.

The sump cover 19 further comprises a connection hole 19b, through which the feeding pipe 11 (see FIG. 2) extends to the main channel 24c.

The filter cover 20 is disposed on the sump cover 19. The mesh filter 20a is mounted to the filter cover 20. The mesh filter 20a covers an upper surface of the filth chamber 24e to prevent dirt collected in the filth chamber 24e from passing through the mesh filter 20a together with wash water.

For example, when dirt and wash water are introduced into the filth chamber 24e, the wash water passes through the mesh filter 20a. However, the dirt is filtered by the mesh filter 20a and is left in the filth chamber 24e.

The wash water separated from the dirt, is introduced into the sump 13 through the inlet holes 19a, and is then continuously circulated through the above-described course.

The heater 36 (see FIG. 2) and the heater cover 42 are disposed at the edge of the sump 13 such that the heater 36 and the heater cover 42 surround the edge of the sump 13.

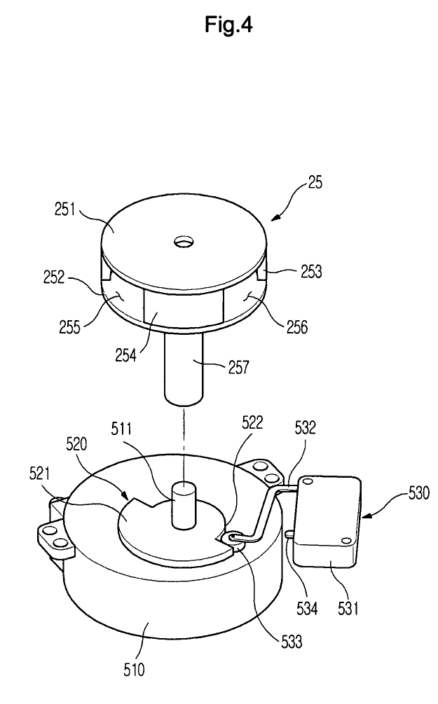

As shown in FIG. 4, the channel control valve 25 is a two-way valve, for example, and comprises an upper disk 251, a lower disk 252 disposed below the upper disk 251 such that the lower disk 252 is spaced a predetermined distance from the upper disk 251, first and second ribs 253 and 254 connected between the upper disk 251 and the lower disk 252, and a motor coupling part 257 extending downward from the center of the lower disk 252 such that the motor coupling part 257 is coupled to the rotary shaft 511.

The first rib 253 and the second rib 254 are formed such that the first rib 253 and the second rib 254 are curved along an edge of the upper disk 251 and the lower disk 252. A length of the curved first rib 253 is greater than a length of the curved second rib 254.

As a result, the first rib 253 closes the inlet of the sub channel 24d. Consequently, wash water does not flow along the sub channel 24d when the quantity of dishes to be washed is small.

First and second openings 255 and 256 are defined between the first rib 253 and the second rib 254, and serve as inlet and outlet ports through which wash water is introduced and discharged such that the wash water can flow along the sub channel 24d.

According to an embodiment of the present invention, the valve driving motor 510 disposed below the channel control valve 25 is a step motor to drive the channel control valve 25 such that the channel control valve 25 can perform an opening or closing function.

The cam 520 mounted to the rotary shaft 511 of the valve driving motor 510 comprises a first outer circumferential face 521 and a second outer circumferential face 522 having a radius less than that of the first outer circumferential face 521.

The position detecting sensor 530 which detects the rotational position of the channel control valve 25, is spaced a predetermined distance from the valve driving motor 510.

The position detecting sensor 530 comprises a sensor body 531, a sensor arm 532 having one end connected with the sensor body 531, a roller 533 connected with another end of the sensor arm 532 while the roller 533 is in rolling contact with the cam 520, and a sensor switch 534 which is brought into contact with or is separated from the sensor arm 532 moving based on a motion of the cam 520.

Consequently, when the first outer circumferential face 521 of the cam 520 is brought into contact with the roller 533, the sensor arm 532 is pushed toward the sensor body 531. As a result, the sensor arm 532 is brought into contact with the sensor switch 534, and therefore, the sensor switch 534 is pushed toward the sensor body 531.

When the cam 520 is rotated in the above-described state, the second outer circumferential face 522 is brought into contact with the roller 533 and the sensor arm 532 is moved toward the cam 520. As a result, the sensor arm 532 is separated from the sensor switch 534.

Hereinafter, an operation of the present invention will be described with reference to the accompanying drawings.

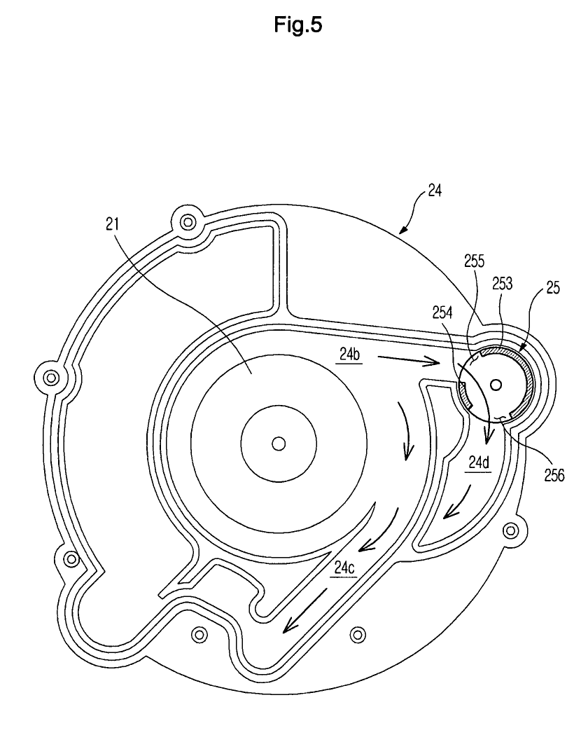

When it is necessary to inject wash water using all the nozzles in the washing tub, as shown in FIG. 5, the wash water is pumped to the main channel 24c and the sub channel 24d.

According to an embodiment of the present invention, a channel control element, such as a valve, is not mounted in the main channel 24c. Consequently, the wash water flows to the main nozzles 10a and 10b (see FIG. 1) along the main channel 24c.

The wash water passing through the sub channel 24d is pumped by the washing impeller 21, passes through the impeller receiving part 24b, the first opening 255, and the second opening 256, and flows to the sub nozzle (not shown) along the sub channel 24d.

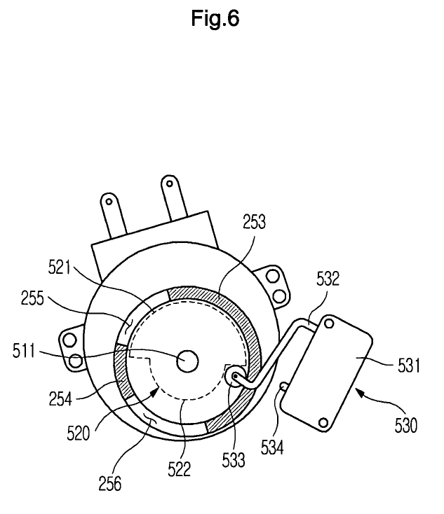

When the sub channel 24d is opened, and the wash water flows through the sub channel 24d, as shown in FIG. 5, the second outer circumferential face 522 of the cam 520 is brought into contact with the roller 533, as shown in FIG. 6. At this time, the sensor arm 532 is separated from the sensor switch 534, and the sensor body 531 recognizes that the sub channel 24d is opened by the channel control valve 25.

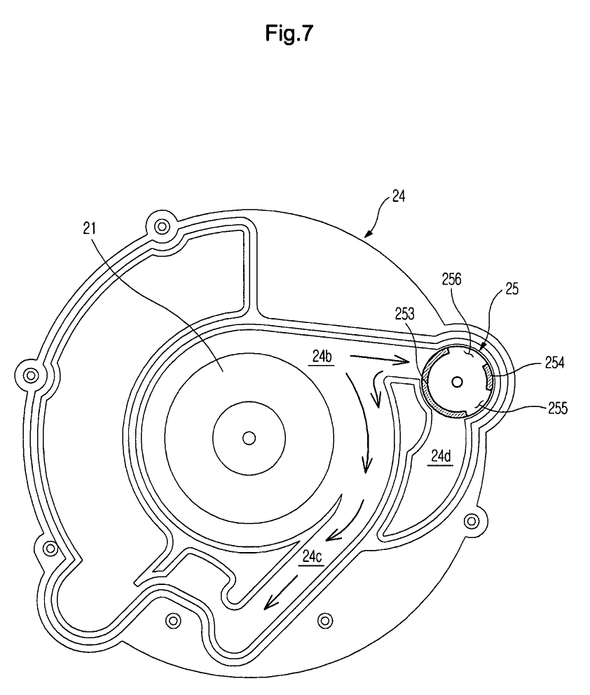

On the other hand, when it is not necessary for the wash water to flow along the sub channel 24d, as shown in FIG. 7, the channel control valve 25 is rotated. As a result, the first rib 253 blocks an inlet of the sub channel 24d to prevent the wash water from being introduced into the sub channel 24d.

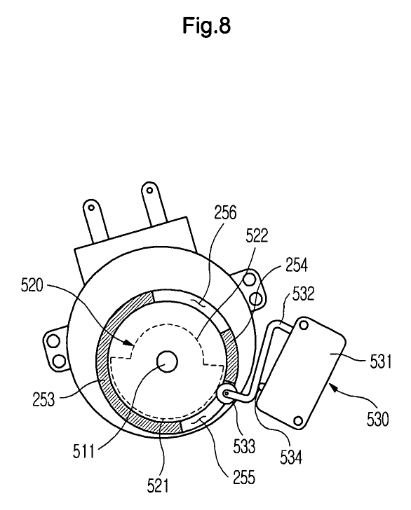

In this state, the roller 533 is brought into contact with the first outer circumferential face 521 of the cam 520, as shown in FIG. 8. At this time, the roller 533 is pushed toward the sensor body 531, and therefore, the sensor arm 532 is brought into contact with the sensor switch 534.

The sensor arm 532 pushes the sensor switch 534 into the sensor body 531. The sensor body 531 recognizes that the sub channel 24d is closed by the channel control valve 25 based on the positional change of the sensor switch 534.

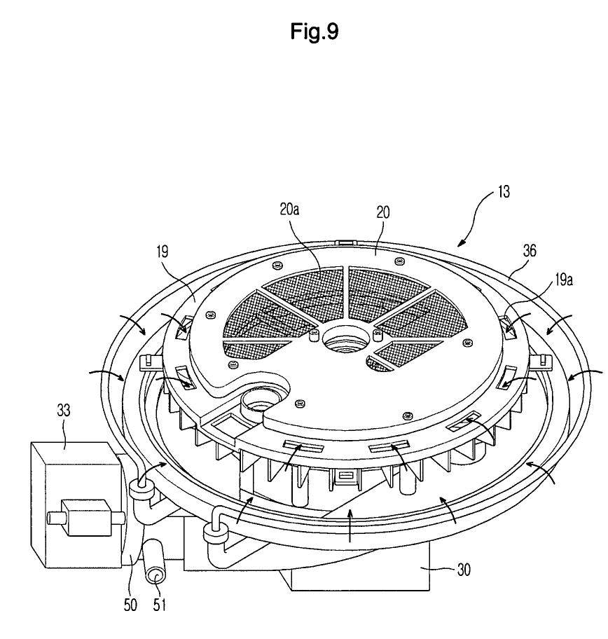

Hereinafter, an operation of the sump according to an embodiment of the present invention will be described with reference to FIGS. 9-12.

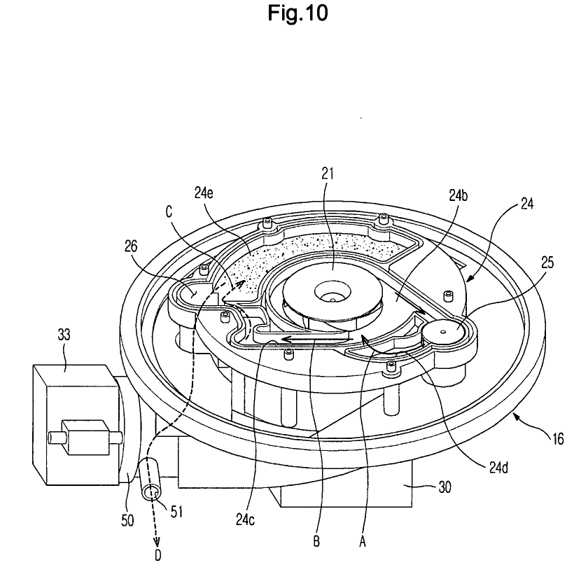

As shown in FIG. 9, wash water is heated by the heater 36, and is then introduced into the sump 13. As shown in FIG. 10, the wash water received in the sump housing 16 is pumped upward to the impeller casing 24 as the washing impeller 21 mounted to the rotary shaft is rotated.

The pumped wash water is moved from the impeller receiving part 24b to the main channel 24c (in the direction indicated by arrow ‘A’) and the sub channel 24d (in the direction indicated by arrow ‘B’) due to a rotating force of the washing impeller. When the sub channel 24d is closed by the channel control valve 25, the wash water is moved only to the main channel 24c.

The wash water flowing along the main channel 24c in the direction indicated by arrow ‘A’ is raised through the feeding pipe 11 (see FIG. 2), due to the strong pressure of the washing impeller 21, and then reaches the main nozzles 10a and 10b (see FIG. 1).

When the quantity of dishes to be washed is small, and therefore, it is necessary to operate only the main nozzles 10a and 10b (see FIG. 1), the sub channel 24d is closed by the channel control valve 25. As a result, wash water flows along only the main channel 24c. The wash water flowing along the main channel 24c reaches the main nozzles 10a and 10b through the feeding pipe 11, and is then injected through the main nozzles 10a and 10b.

When the quantity of dishes to be washed is large, and therefore, it is necessary to operate the sub nozzle 10c (see FIG. 1) as well as the main nozzles 10a and 10b, the sub channel 24d is opened by the channel control valve 25. As a result, wash water flows in the direction indicated by arrow ‘B’. Subsequently, the wash water reaches the sub nozzle 10c, and is then injected through the sub nozzle 10c.

The filth chamber 24e is connected to the main channel 24c. Consequently, dirt mixed with some wash water is moved (in the direction indicated by arrow ‘C’), and is then collected in the filth chamber 24e.

The drainage connection pipe 26 connected with the drainage pump 33 is adjacent to an inlet of the filth chamber 24e. Consequently, the dirt collected in the filth chamber 24e is discharged to an outside (in the direction indicated by arrow ‘D’) during an operation of the drainage pump 33.′

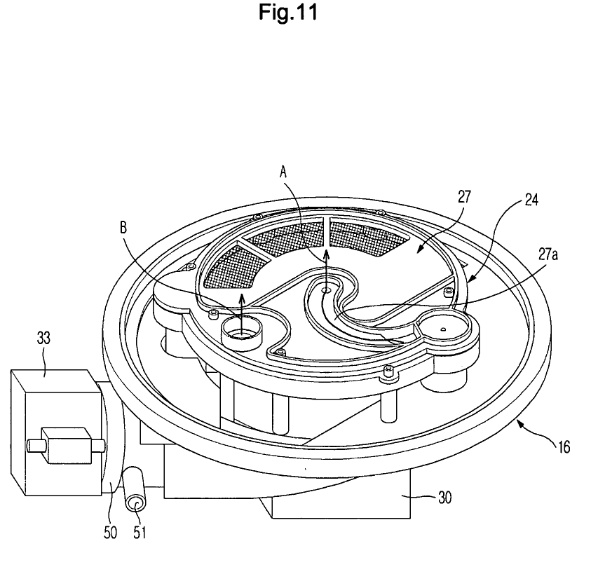

As shown in FIG. 11, the guide channel 27a is formed at the impeller casing cover 27 disposed on the impeller casing 24 such that the guide channel 27a communicates with the sub channel 24d (see FIG. 7)

When the washing impeller 21 (see FIG. 7) is operated in a state that the sub channel 24d is opened by the channel control valve 25 (see FIG. 7), wash water also flows along the sub channel 24d. The wash water flowing along the sub channel 24d is guided to a center of the impeller casing cover 27 along the guide channel 27a, and is moved to the sub nozzle 10c (see FIG. 1) in the direction indicated by arrow ‘A’, and is injected through the sub nozzle 10c.

Arrow ‘B’ indicates a flow direction of the wash water flowing to the main nozzles 10a and 10b (see FIG. 1).

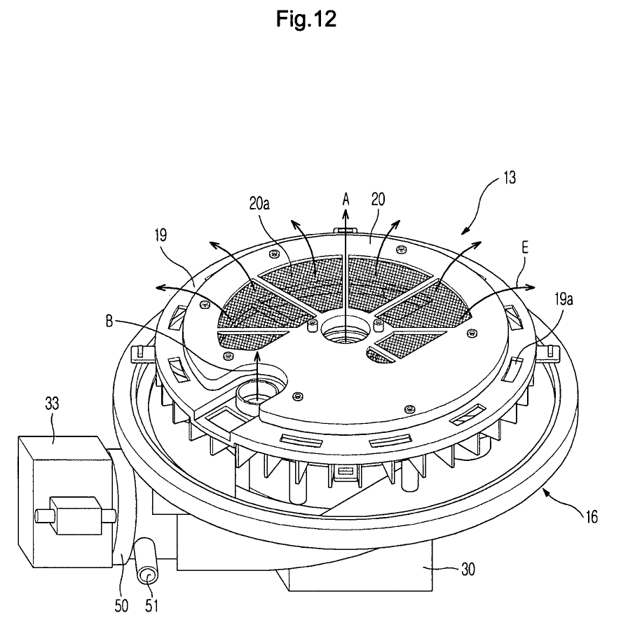

As shown in FIG. 12, wash water and dirt introduced into the filth chamber 24e (see FIG. 10) along the main channel 24c (see FIG. 10) are pushed toward the mesh filter 20a due to the pressure of subsequent wash water. However, the dirt does not pass through the mesh filter 20a. Consequently, the dirt is left in the filth chamber 24e (see FIG. 10). Only the wash water passes through the mesh filter 20a in the direction indicated by arrow ‘E’, and is then discharged out of the sump 13.

The discharged wash water is reintroduced into the sump 13, and flows inside the sump 13 to perform the washing operation as previously described.

As apparent from the above description, according to an embodiment of the present invention, only the main nozzles are operated when the quantity of dishes to be washed is small, and the main nozzles and the sub nozzle are simultaneously operated when the quantity of dishes to be washed is large. Consequently, it is possible to control the amount of wash water based on the quantity of dishes.

Furthermore, according to an embodiment of the present invention, an injection pressure dropping element, such as a channel control valve, is not mounted in the main channel. Consequently, it is possible to prevent an abrupt drop of the injection pressure of wash water flowing to the main nozzles along the main channel, thereby improving the washing efficiency.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A dish washing machine comprising:
a washing tub to wash dishes therein;
main nozzles disposed in the washing tub to constantly inject wash water when washing dishes;
a sub nozzle disposed in the washing tub to selectively inject wash water when washing dishes;
a sump mounted in the wash tub to receive wash water and to pump the wash water to the respective nozzles;
a main channel disposed in the sump and connected with the main nozzles;
a sub channel disposed in the sump while being separated from the main channel, the sub channel being connected to the sub nozzle; and
a channel control valve disposed in the sub channel to intermit the flow of wash water flowing to the sub nozzle.

2. The dish washing machine according to claim 1, wherein
the sump comprises a washing impeller to pump the wash water and an impeller casing comprising an impeller receiving part, in which the washing impeller is received, and
the main channel and the sub channel are formed at the impeller casing such that the main channel and the sub channel diverge from the impeller receiving part.

3. The dish washing machine according to claim 1, wherein the channel control valve is rotatably mounted in an inlet of the sub channel.

4. The dish washing machine according to claim 2, wherein the main channel extends from the impeller receiving part to an edge of the impeller casing in a shape of a curve, to prevent an instantaneous drop of the injection pressure of wash water flowing along the main channel.

5. The dish washing machine according to claim 2, wherein the impeller casing comprises a filth chamber communicating with the main channel to collect dirt mixed with wash water.

6. The dish washing machine according to claim 5, wherein the main channel, the sub channel, and the filth chamber are integrally formed at the impeller casing.

7. The dish washing machine according to claim 1, wherein the sub channel comprises a valve engaging hole in which the channel control valve is engaged, and
the dish washing machine further comprises a valve driving motor disposed below the valve engaging hole, the valve driving motor being coupled to the channel control valve.

8. The dish washing machine according to claim 7, further comprising:
a motor shaft extending from the valve driving motor and coupled with the channel control valve;
a cam coupled with the motor shaft; and
a sensor to contact an outer circumferential face of the cam to detect a motion of the channel control valve.

9. The dish washing machine according to claim 8, wherein the sensor comprises:
a sensor arm to move with a movement of the cam,
a roller coupled with one end of the sensor arm, the roller contacting the outer circumferential face of the cam,
a sensor body, to which another end of the sensor arm is fixed, and
a sensor switch disposed at the sensor body such that the sensor switch is brought into contact with or is separated from the sensor arm.

10. The dish washing machine according to claim 1, wherein the channel control valve is a two-way valve comprising:
an upper disk;
a lower disk disposed below the upper disk such that the lower disk is spaced a predetermined distance from the upper disk;
first and second ribs connected between the upper disk and the lower disk, the first and second ribs being separated from each other; and
first and second openings defined between the first rib and the second rib.

11. A dish washing machine comprising:
a washing tub to wash dishes therein;
main nozzles disposed in the washing tub to constantly inject wash water when washing dishes;
a sub nozzle disposed in the washing tub to selectively inject wash water when washing dishes;
a sump mounted in the wash tub to pump wash water to the sub nozzle and the main nozzles;
a main channel disposed in the sump and connected with the main nozzles to guide wash water to the main nozzles;
a sub channel disposed in the sump, the sub channel being connected to the sub nozzle to selectively guide wash water to the sub nozzle;
a channel control valve disposed in the sub channel to open and close the sub channel so as to intermit a flow of wash water; and
a filth chamber communicating with the main channel to collect dirt contained in wash water.

12. The dish washing machine according to claim 11, wherein
the sump comprises a washing impeller to pump the wash water, an impeller casing comprising an impeller receiving part, in which the washing impeller is received, and an impeller casing cover to cover the impeller casing,
the main channel and the sub channel are formed at the impeller casing such that the main channel and the sub channel diverge from the impeller receiving part, and
the impeller casing cover comprises a guide channel communicating with the sub channel to guide the wash water from the sub channel to the sub nozzle.

13. The dish washing machine according to claim 11, further comprising:
a feeding pipe connected between the sump and the main nozzles, wherein
the feeding pipe is disposed adjacent to an edge of the sump, and the sub nozzle is rotatably coupled with a center of the sump.

14. The dish washing machine according to claim 11, wherein the channel control valve is a two-way valve.

15. A dish washing machine having a washing tub therein, comprising:
first and second main nozzles and a sub nozzle to selectively inject wash water into the washing tub of the dish washing machine;
a sump mounted to the washing tub to receive was water and to pump the wash water to the respective nozzles;
a main channel connect with the first and second main nozzles and disposed in the sump;
a sub channel disposed in the sump separately from the main channel such that the sub channel is connected with the sub nozzle; and
wherein the wash water is selectively injected through the first and the second main nozzles or the sub nozzle based upon an amount of dishes to be washed in the washing tub.

16. The dish washing machine of claim 15, wherein the first and second main nozzles are positioned at an upper part and middle part of the washing tub, and the sub nozzle is directly connected with an upper center part of the sump, such that when the amount of dishes is small, the dishes are placed in an upper basket of the dish washing machine, and the wash water is only injected through the first and second main nozzles.

17. The dish washing machine of claim 16, further comprising a channel control valve is rotatably mounted in the sub channel to intermit the flow of wash water flowing to the sub nozzle.

18. The dish washing machine of claim 17, wherein the channel control valve is a two-way valve comprising:
an upper disk;
a lower disk disposed below the upper disk such that the lower disk is spaced a predetermined distance from the upper disk;
first and second ribs connected between the upper disk and the lower disk, the first and second ribs being separated from each other; and
first and second openings defined between the first rib and the second rib.

19. The dish washing machine of claim 18, wherein the first rib and the second rib are curved along an edge of the upper disk and the lower disk, and a length of the curved first rib is greater than a length of the curved second rib.

20. The dish washing machine of claim 19, further comprising:
a valve driving unit disposed below the channel control valve to drive the channel control valve, and comprising a valve motor to drive the channel control valve, a cam coupled with a rotary shaft of the valve driving motor and a position detection sensor to detect a rotational position of the channel control valve through the cam.

21. The dish washing machine of claim 15, further comprising:
a heater mounted at an edge of the sump in a shape of a ring; and
a heater cover to be mounted on the heater and comprising a plurality of through holes through which wash water flows to the heater,
wherein the wash water is heated by the heater and then introduced into the sump.

22. The dish washing machine ofclaim 15, further comprising:
a sump cover mounted on the sump, and comprising inlet holes arranged in predetermined intervals along an edge of the sump cover, wherein wash water is introduced into the sump through the inlet holes.
